(19) United States
(12) Patent Application Publication
(10) Pub. No.: US 2005/0119881 A1
(43) Pub. Date: Jun. 2, 2005

(54) Method for automatic gain control of encoded digital audio streams

(76) Inventors: James L. Seidman, Naperville, IL (US); Douglas Todd Rylaarsdam, Lombard, IL (US)

Correspondence Address: Welsh & Katz, Ltd.;Jon P. Christensen, 22nd Floor, 120 South Riverside Plaza, Chicago, IL, 60606, US

(21) Appl. No.: 10/982,063

(22) Filed: Nov. 4, 2004

Related U.S. Application Data
(60) Provisional application No. 60/526,393, filed on Dec. 2, 2003.

(51) Int. Cl. G10L 19/14

(52) U.S. Cl. 704/225

(57) ABSTRACT

A method and apparatus are provided for controlling a gain of an audio stream. The method includes the steps of collecting a plurality of samples of the audio stream, squaring a magnitude of a representation of at least some samples of the collected plurality of samples, summing the squared representations and adjusting a magnitude of the plurality of samples by a value equal to a square root of a ratio between the sum and a predetermined reference value.

### FIELD OF THE INVENTION

The field of the invention relates to audio streams and more particularly to the use of gain control in audio streams.

### BACKGROUND OF THE INVENTION

The use of automatic gain control (AGC) in audio circuits is well known. Typically, AGC functions through the use of a feedback signal wherein a signal level of the audio signal is measured and used to control a gain of an upstream amplifier.

In general, AGC involves the automatic maintenance of a nearly constant output level of an amplifying circuit by adjusting the amplification in inverse proportion to an input signal strength. AGC is widely used in broadcast receivers to accommodate widely varying incoming signals and to allow for a sound that remains at nearly a constant volume.

The use of AGC in audio circuits inherently involves at least some filtering. Sound in the audible range must be given precedence over changes in volume in the sub-audible and ultrasound ranges. In general, an energy storage device, such as a capacitor may be used to collect and average a sound energy over a time period.

While prior art AGC systems generally work well, they are typically implemented in hardware. However, some audible applications cannot be implemented in hardware. Accordingly, a need exists for a method of controlling volume that is not dependent upon circuit devices.

### SUMMARY

A method and apparatus are provided for controlling a gain of an audio stream. The method includes the steps of collecting a plurality of samples of the audio stream, squaring a magnitude of a representation of at least some samples of the collected plurality of samples, summing the squared representations and adjusting a magnitude of the plurality of samples by a value equal to a square root of a ratio between the sum and a predetermined reference value.

### BRIEF DESCRIPTION OF THE DRAWINGS

FIG. 1 is a block diagram of a conferencing system shown in a context of use under an illustrated embodiment of the invention;

FIG. 2 depicts the conferencing system of FIG. 1; and

FIG. 3 is a block diagram that depicts an automatic gain control system that may be used by the system of FIG. 1.

### DETAILED DESCRIPTION OF AN ILLUSTRATED EMBODIMENT

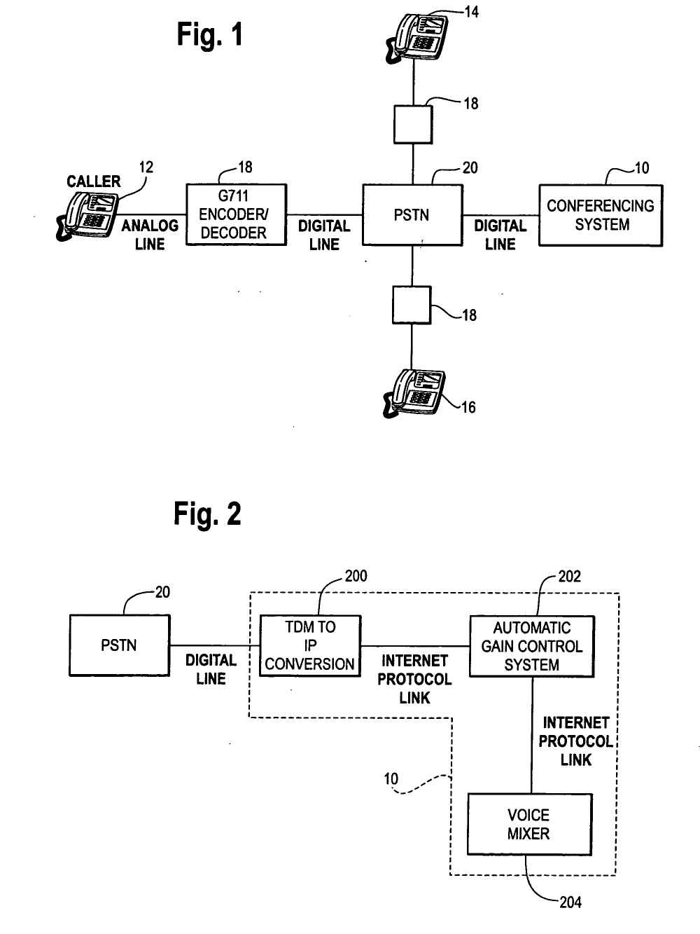

FIG. 1 depicts a conferencing system 10 shown generally in accordance with an illustrated embodiment of the invention. Under illustrated embodiments, the system 10 allows any of a number of parties 12, 14, 16 to participate in a conference call through the PSTN 20. The conferencing system 10 detects a voice energy of each of the participants 12, 14, 16 and maintains a relatively constant and equal volume among the participants 12, 14, 16.

As depicted in FIG. 1, the telephones of each of the participants 12, 14, 16 may be provided with an encoder/decoder 18 that allows participants to exchange voice information with the PSTN 20 under an appropriate audio compression format, as defined by the ITU-T (e.g., G.711). Encoding/decoding under the G.711 standard may be performed using either A-law or μ-law algorithms.

In order to set up a conference call, the parties 12, 14, 16 may dial the telephone number of a gateway 200 (FIG. 2) that connects between the PSTN 20 and a local area network (LAN) of the conferencing system 10. Within the gateway 200, incoming voice samples from each party 12, 14, 16 may converted into a packet format for processing. Packetized samples may subsequently be normalized to a constant volume level (e.g., between −1 and 1) within the automatic gain control system 202 and mixed for distribution to the participants 12, 14, 16 within a mixer 204. Mixing in this context means that the normalized voice samples received from any two participants (e.g. “a” and “b”) are combined and sent to the third participant “c” using any appropriate formula (e.g., c=(a+b)−(a*b)), where a and b are both positive. Other variations and formulas may be used when a and/or b are negative. In addition, it should be understood that while the figures show two participants, any number of parties may participate.

In general, when audio streams are mixed, such as by a conference call system 10, it is useful to first perform automatic gain control (AGC) to bring the audio streams to similar volume levels. When AGC is done in software, it is necessary to perform the gain control very efficiently. This is complicated by the fact that audio streams are often encoded using some compression algorithm, such as the standard G.711 codec.

The G.711 codec uses a representation of the voice sample similar to floating point numbers. For G.711, each 8-bit sample may be encoded using the format shown below.

| | | |
|---|---|---|
| BIT 1: Sign (p | Bits 2-4: Segment | Bits 5-8: |
| bit) | Number (s bits) | Amplitude within a |
| | | segment (q bits) |

The segment number is similar to a floating point exponent, and the amplitude number is similar to a mantissa. G.711 includes two different encoding schemes, A-law and μ-law, which differ in how they assign segments, but they have essentially equivalent functionality. Using the example of A-law, if the level is taken to be between 0 and 15, inclusive, and the segment between 0 and 7, inclusive, then the magnitude of a sample would be given by the equality, m=(16+q)2^{s}. The total sound energy of a series of samples would be equal to the square root of the sum of the squares of the magnitudes of all of the samples. The goal of AGC would be to adjust the samples such that the input streams of each of the participants 12, 14, 16 have roughly equal total sound energy during periods of speech.

Under illustrated embodiments of the invention, it has been found that it is sufficient to approximate the magnitude of the speech samples by ignoring the level (bits 5-8), and using only the segment information (bits 2-4). Therefore a proxy for the total sound energy can be computed by taking the square root of the sum of the squares of the value 2^{s} for each sample. To reduce computation time and avoid the need for floating point arithmetic, the described method does not compute the square root, and instead computes the sum of the value 2^{2s} for each sample, thus representing the square of the energy level. Since the sample is in binary, the squaring of a number involves shifting the bits by one position. This total will be referred to as T.

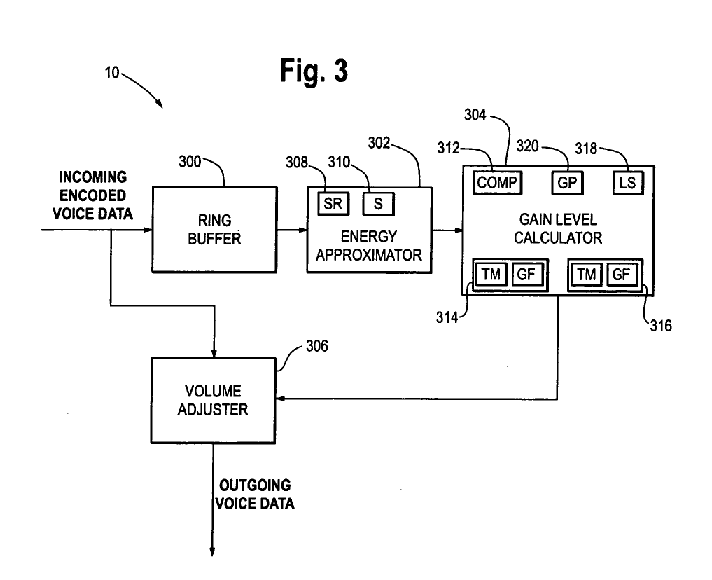

The specific method used for calculating T is to provide a ring buffer 300 (FIG. 3) containing a number (e.g., 65,536) of voice samples. The ring buffer entries are initialized by loading a sequence of values from the voice connection that represent a reference level of sound energy. In effect, the ring buffer entries are loaded with a set of values that represent a reference level of sound energy, i.e., a typical volume of speech. As new samples arrive, they are added to the buffer. Samples that have a segment level of zero are discarded rather than added to the buffer because it is possible for them to represent pauses between speech rather than actual sound. As each new sample is added to the buffer, the oldest sample may be discarded.

A squared value 2^{2s} may be determined within a shift register 308 for each sample within the ring buffer 300. The values 2^{2s} determined from each sample within the ring buffer 300 may be added within an adder 310 to provide a value, T. After initialization, the values 2^{2s} for the new samples loaded into the ring buffer 300 may be added to a value T, and the value 2^{2s} for the samples being removed from the buffer may be subtracted from T.

A reference value T₁ may be determined which represents the expected value of T for a reference audio level input. When T is approximately equal to T₁, it indicates that a gain factor of 1 should be applied, i.e., the input signal should not be modified. When T₁ is not equal to T, then it indicates that the square root of the ratio between T₁ and T should be applied as the gain factor to each of the samples.

A series of threshold values Tₙ₁-Tₙ₂ and associated gain factors may be determined based upon T₁. For example, if a threshold value Tₙ is chosen (T_{15/16}) to simulate a sequence of samples that are each 1/15 larger than T₁, then T_{15/16} is equal to T₁*(16/15)², indicating that if T approximates T_{15/16}, then a gain factor of 15/16 should be applied. This suggests that each sample should be reduced in volume by multiplying the linear equivalent value of each sample by 15/16. Any number of gain level combinations 314, 316 (each with a threshold value Tₙ and associated gain factor) can be created, and for any gain level x, Tₓ=T₁*(1/x) ², where the adjustment is squared because T represents the square of the approximate speech energy, since the square root function was not previously applied.

During use, a value T is calculated for the samples within the ring buffer 300 during each time interval (e.g., every 20 ms). The calculated value T is them compared with the reference threshold values Tₙ 314, 316 within a comparator 312 to identify a closest match. Once the closest match is identified between the value T and the threshold values Tₙ, an associated gain factor may be retrieved from the matched file 314, 316. The retrieved gain factor may be multiplied by each voice sample within a volume adjuster 306.

In addition to calculating the appropriate gain level, for any given audio stream, the system also detects and keeps track of the highest magnitude sample 318 that has been received. Detection may be performed by comparing each sample with the largest sample 318 and storing the larger as the new sample 318. The largest sample 318 may be used by a gain processor 320 to determine a set of values Tₙ and associated gain factors.

The number 318 is never reset for the life of the audio stream. The gain processor 320 calculates a set of threshold values Tₙ and associated gain factors so that this sample 318 would never be clipped. In other words, the system will never choose a gain factor that, when applied to the highest magnitude sample, would cause the adjusted sample to exceed the possible sample range. This allows the gain adjustment to be done without explicit testing for overflow or clipping conditions.

A specific embodiment of method and apparatus for controlling the gain of an audio stream has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of controlling a gain of an audio stream, such method comprising the steps of:
collecting a plurality of samples of the audio stream;
squaring a magnitude of a representation of at least some samples of the collected plurality of samples;
summing the squared representations; and
adjusting a magnitude of the plurality of samples by a value equal to a square root of a ratio between the sum and a predetermined reference value.

2. The method of controlling the gain as in claim 1 further comprising discarding any samples of the plurality of samples below a predetermined minimum threshold value.

3. The method of controlling the gain as in claim 1 wherein the step of collecting the plurality of samples further comprises recovering successive samples from a data stream encoded under an audio compression format.

4. The method of controlling the gain as in claim 1 wherein the audio compression format further comprises G.711.

5. The method of controlling the gain as in claim 3 further comprising saving the successive samples in adjacent positions of a ring buffer.

6. The method of controlling the gain as in claim 5 further comprising for each new sample recovered from the data stream and saved into the ring buffer, discarding an relatively oldest sample from the ring buffer.

7. The method of controlling the gain as in claim 5 wherein the ring buffer further comprises a capacity of at least 60,000 samples.

8. The method of controlling the gain as in claim 1 wherein the representation of the sample under the G.711 format further comprises a segment number of the sample, but not a level number.

9. The method of controlling the gain as in claim 1 wherein the sample further comprises audio information encoded under an A-law format.

10. The method of controlling the gain as in claim 1 wherein the sample further comprises audio information encoded under a μ-law format.

11. The method of controlling the gain as in claim 1 wherein the step of adjusting a magnitude of the sample further comprises providing a plurality of predetermined threshold values for the sum and a respective square root of the ratio associated with each of the threshold values.

12. The method of controlling the gain as in claim 11 wherein the step of adjusting a magnitude of the sample further comprises selecting an associated square root of a threshold value of the plurality of threshold values for adjusting the samples when the sum exceeds the threshold value.

13. An apparatus for controlling a gain of an audio stream, such apparatus comprising:
means for collecting a plurality of samples of the audio stream;
means for squaring a magnitude of a representation of at least some samples of the collected plurality of samples;
means for summing the squared representations; and
means for adjusting a magnitude of the plurality of samples by a value equal to a square root of a ratio between the sum and a predetermined reference value.

14. The apparatus for controlling the gain as in claim 13 further comprising means for discarding any samples of the plurality of samples below a predetermined minimum threshold value.

15. The apparatus for controlling the gain as in claim 13 wherein the means for collecting the plurality of samples further comprises means for recovering successive samples from a data stream encoded under an audio compression format.

16. The apparatus for controlling the gain as in claim 14 wherein the audio compression format further comprises G.711.

17. The apparatus for controlling the gain as in claim 15 further comprising means for saving the successive samples in adjacent positions of a ring buffer.

18. The apparatus for controlling the gain as in claim 17 further comprising for each new sample recovered from the data stream and saved into the ring buffer, means for discarding an relatively oldest sample from the ring buffer.

19. The apparatus for controlling the gain as in claim 17 wherein the ring buffer further comprises a capacity of at least 60,000 samples.

20. The apparatus for controlling the gain as in claim 13 wherein the representation of the sample under the G.711 format further comprises a segment number of the sample, but not a level number.

21. The apparatus for controlling the gain as in claim 13 wherein the sample further comprises means for encoding audio information under an A-law format.

22. The apparatus for controlling the gain as in claim 13 wherein the sample further comprises means for encoding audio information under a μ-law format.

23. The apparatus for controlling the gain as in claim 13 wherein the means for adjusting a magnitude of the sample further comprises means for providing a plurality of predetermined threshold values for the sum and a respective square root of the ratio associated with each of the threshold values.

24. The apparatus for controlling the gain as in claim 23 wherein the means for adjusting a magnitude of the sample further comprises selecting an associated square root of a threshold value of the plurality of threshold values for adjusting the samples when the sum exceeds the threshold value.

25. An apparatus for controlling a gain of an audio stream, such apparatus comprising:
a ring buffer that collects a plurality of samples of the audio stream;
a shift register that squares a magnitude of a representation of at least some samples of the collected plurality of samples;
a added that sums the squared representations; and
a volume adjuster that adjusts a magnitude of the plurality of samples by a value equal to a square root of a ratio between the sum and a predetermined reference value.

26. The apparatus for controlling the gain as in claim 25 wherein the means for collecting the plurality of samples further comprises a connection to the PSTN that recovers successive samples from a data stream encoded under an audio compression format.

27. The apparatus for controlling the gain as in claim 25 wherein the audio compression format further comprises G.711.

28. The apparatus for controlling the gain as in claim 25 wherein the ring buffer further comprises a capacity of at least 60,000 samples.

29. The apparatus for controlling the gain as in claim 25 wherein the representation of the sample under the G.711 format further comprises a segment number of the sample, but not a level number.

30. The apparatus for controlling the gain as in claim 25 wherein the sample further comprises means for encoding audio information under an A-law format.

31. The apparatus for controlling the gain as in claim 25 wherein the sample further comprises means for encoding audio information under a μ-law format.

32. The apparatus for controlling the gain as in claim 25 further comprising a plurality of predetermined threshold values for the sum and a respective square root of the ratio associated with each of the threshold values.

33. The apparatus for controlling the gain as in claim 32 further comprising a comparator that selects an associated square root of a threshold value of the plurality of threshold values for adjusting the samples when the sum exceeds the threshold value.
